(19) United States
(12) Patent Application Publication
(10) Pub. No.: US 2014/0230156 A1
(43) Pub. Date: Aug. 21, 2014

(54) METHOD OF LAUNDERING A FABRIC

(71) Applicant: The Procter & Gamble Company, Cincinnati, OH (US)

(72) Inventors: Neil Joseph Lant, Newcastle upon Tyne (GB); Linsey Sarah Bennie, Newcastle upon Tyne (GB); Steven George Patterson, Tyne & Wear (GB); Lindsay Suzanne Bewick, Tyne & Wear (GB)

(73) Assignee: The Procter & Gamble Company, Cincinnati, OH (US)

(21) Appl. No.: 14/183,649

(22) Filed: Feb. 19, 2014

(30) Foreign Application Priority Data
Feb. 19, 2013 (EP) 13155780.3

(51) Int. Cl. C11D 3/00; C11D 1/02

(52) U.S. Cl. CPC C11D 3/001; C11D 1/02
USPC 8/137

(57) ABSTRACT

A method of laundering a fabric, comprising the steps of; (i) contacting a fabric with a lipid esterase; (ii) contacting the fabric from step (i) with a cationically charged fabric softening active, wherein the cationically charged fabric softening active is a substrate for the lipid esterase; (iii) contacting the fabric from step (ii) with a laundry detergent composition, wherein the laundry detergent composition comprises an anionic surfactant, wherein the anionic surfactant is present at the ratio of anionic surfactant to fabric on a weight to weight basis of from 1:200 to 1:500.

### FIELD OF THE INVENTION

The present invention relates to methods of laundering fabrics.

### BACKGROUND OF THE INVENTION

Fabric softening compositions are often added by consumers to the rinse step of a fabric washing operation. Fabric softeners impart a number of sensorial benefits that consumers enjoy, including softness and freshness. Oftentimes, softness is provided by esterified cationic surfactants.

Laundry detergent compositions are used to provide fabric cleaning benefit in the wash step of a laundry operation. However, the ability of such compositions to effectively clean fabrics is reduced by the presence of cationic surfactant on fabrics that has been carried over from previous rinse steps. Anionic detersive surfactants present in the laundry detergent compositions provide stain removal benefits to fabrics, but they also work to strip carried-over cationic surfactant from the fabrics to allow other components of the laundry detergent composition to provide their benefit to the fabric. However, the cleaning performance of a laundry detergent composition is reduced because of the loss of available anionic surfactant due to the interaction of the cationic surfactant and anionic surfactant.

This problem is exacerbated by a current market trend to compact laundry detergent products. In order to compact product, lower concentrations of ingredient including anionic surfactant are used. This results in a decrease in cleaning performance due to the higher ratio of cationic surfactant carry-over to anionic surfactant present in the wash liquor. Furthermore, environmental and energy consumption concerns mean that consumers tend to use colder wash temperatures and shorter wash cycle times. This again makes it harder for the anionic surfactant present to effectively strip the cationic surfactant from the fabric.

Thus, there is a need in the art for a means to effectively remove carried-over cationic surfactant on fabric in the presence of low anionic surfactant levels. There is a further need in the art for a means to effectively remove carried-over cationic surfactant on fabrics at low wash temperatures and also at short wash cycles.

It was surprisingly found that the method of the present invention solved this problem. The present method comprises the steps of contacting a fabric with a lipid esterase followed by the step of contacting it with cationic surfactant. It was surprisingly found that the presence of the lipid esterase on the fabric prior to the addition of cationic surfactant improved cationic surfactant removal in a subsequent wash.

### SUMMARY OF THE INVENTION

The present invention is to a method of laundering a fabric, comprising the steps of; (i) contacting a fabric with a lipid esterase; (ii) contacting the fabric from step (i) with a cationically charged fabric softening active, wherein the cationically charged fabric softening active is a substrate for the lipid esterase; (iii) contacting the fabric from step (ii) with a laundry detergent composition, wherein the laundry detergent composition comprises an anionic surfactant, wherein the anionic surfactant is present at the ratio of anionic surfactant to fabric on a weight to weight basis of from 1:150 to 1:500.

### DETAILED DESCRIPTION OF THE INVENTION

The present invention is to a method of laundering a fabric, comprising the steps of;
i) contacting a fabric with a lipid esterase;
ii) contacting the fabric from step (i) with a cationically charged fabric softening active, wherein the cationically charged fabric softening active is a substrate for the lipid esterase;
iii) contacting the fabric from step (ii) with a laundry detergent composition, wherein the laundry detergent composition comprises an anionic detersive surfactant, wherein the anionic surfactant is present at the ratio of anionic detersive surfactant to fabric on a weight to weight basis of from 1:150 to 1:500.

A fabric may be contacted with a lipid esterase in step (i) in the wash cycle of a washing operation, followed by being contacted with a cationically charged fabric softening active in step (ii) in a rinse step of a wash operation. The fabric may then be dried. The fabric may then be worn by a consumer or used in another way for its intended use. Following use of the fabric, the fabric may then be contacted with the laundry detergent composition in step (iii). Without wishing to be bound by theory, it is believed that the lipid esterase contacted to the fabric in step (i) acts ‘out of the wash’ to hydrolyse the cationically charged fabric softening active contacted in step (ii). Lipid esterases are a class of enzymes that hydrolyse lipid esters, i.e. split the ester into acid and alcohol. Thus, the cationically charged softening active provides softening benefit but since it is pre-hydrolysed out of the wash, it is more effectively stripped from the fabric in step (iii) even in the presence of low levels of anionic surfactant.

### Step (i)

The method of the present invention comprises a step (i) of contacting a fabric with a lipid esterase.

The fabric may be any suitable fabric. The fabric may comprise natural or synthetic materials or a combination thereof. The fabric may comprise cotton, polycotton, polyester, or a combination thereof. The fabric may comprise cotton.

The lipid esterase may be any suitable lipid esterase. The lipid esterase may comprise at least a first and a second lipid esterase. The lipid esterase may comprise more than two lipid esterases. The lipid esterase may be a lipase, or a cutinase, or a combination thereof.

The lipid esterase may be selected from the following:

(1) Triacylglycerol lipases (E.C. 3.1.1.3)

(2) Carboxylic ester hydrolase (E.C. 3.1.1.1)

(3) Cutinase (E.C. 3.1.1.74)

(4) Sterol esterase (E.C. 3.1.1.13)

(5) Wax-ester hydrolase (E.C. 3.1.1.50)

By ‘E.C. class’ we herein mean the Enzyme Commission class. The Enzyme Commission class is an international recognized enzyme classification scheme based on chemical reactions that the enzymes catalyse.

Suitable triacylglycerol lipases can be selected from variants of the Humicola lanuginosa (Thermomyces lanuginosus) lipase. Other suitable triacylglycerol lipases can be selected from variants of Pseudomonas lipases, e.g., from P. alcaligenes or P. pseudoalcaligenes (EP 218 272), P. cepacia (EP 331 376), P. stutzeri (GB 1,372,034), P. fluorescens, Pseudomonas sp. strain SD 705 (WO 95/06720 and WO 96/27002), P. wisconsinensis (WO 96/12012), Bacillus lipases, e.g., from B. subtilis (Dartois et al. (1993), Biochemica et Biophysica Acta, 1131, 253-360), B. stearothermophilus (JP 64/744992) or B. pumilus (WO 91/16422).

Suitable carboxylic ester hydrolases can be selected from wild-types or variants of carboxylic ester hydrolases endogenous to B. gladioli, P. fluorescens, P. putida, B. acidocaldarius, B. subtilis, B. stearothermophilus, Streptomyces chrysomallus, S. diastatochromogenes and Saccaromyces cerevisiae.

Suitable cutinases can be selected from wild-types or variants of cutinases endogenous to strains of Aspergillus, in particular Aspergillus oryzae, a strain of Alternaria, in particular Alternaria brassiciola, a strain of Fusarium, in particular Fusarium solani, Fusarium solani pisi, Fusarium oxysporum, Fusarium oxysporum cepa, Fusarium roseum culmorum, or Fusarium roseum sambucium, a strain of Helminthosporum, in particular Helminthosporum sativum, a strain of Humicola, in particular Humicola insolens, a strain of Pseudomonas, in particular Pseudomonas mendocina, or Pseudomonas putida, a strain of Rhizoctonia, in particular Rhizoctonia solani, a strain of Streptomyces, in particular Streptomyces scabies, a strain of Coprinopsis, in particular Coprinopsis cinerea, a strain of Thermobifida, in particular Thermobifida fusca, a strain of Magnaporthe, in particular Magnaporthe grisea, or a strain of Ulocladium, in particular Ulocladium consortiale.

In a preferred embodiment, the cutinase is selected from variants of the Pseudomonas mendocina cutinase described in WO 2003/076580 (Genencor), such as the variant with three substitutions at I178M, F180V, and S205G.

In another preferred embodiment, the cutinase is a wild-type or variant of the six cutinases endogenous to Coprinopsis cinerea described in H. Kontkanen et al, App. Environ. Microbiology, 2009, p2148-2157

In another preferred embodiment, the cutinase is a wild-type or variant of the two cutinases endogenous to Trichoderma reesei described in WO2009007510 (VTT).

In a most preferred embodiment the cutinase is derived from a strain of Humicola insolens, in particular the strain Humicola insolens DSM 1800. Humicola insolens cutinase is described in WO 96/13580 which is hereby incorporated by reference. The cutinase may be a variant, such as one of the variants disclosed in WO 00/34450 and WO 01/92502. Preferred cutinase variants include variants listed in Example 2 of WO 01/92502.

Suitable sterol esterases may be derived from a strain of Ophiostoma, for example Ophiostoma piceae, a strain of Pseudomonas, for example Pseudomonas aeruginosa, or a strain of Melanocarpus, for example Melanocarpus albomyces.

In a most preferred embodiment the sterol esterase is the Melanocarpus albomyces sterol esterase described in H. Kontkanen et al, Enzyme Microb Technol., 39, (2006), 265-273.

Suitable wax-ester hydrolases may be derived from Simmondsia chinensis.

The lipid esterase may be selected from an enzyme in E.C. class 3.1 or 3.2 or a combination thereof. The lipid esterase may comprise an enzyme selected from E.C. class 3.1.1.1 or 3.1.1.3 or 3.1.1.74 or a combination thereof. The lipid esterase may comprise an enzyme selected from E.C. class 3.1.1.3. The lipid esterase may comprise a variant having at least 90% sequence identity to wild-type lipase from Thermomyces lanuginosus and having sequence substitutions T231R and N233R, or a variant corresponding to claim 5, part (u) of EP1290150B1, or a combination thereof. The lipid esterase may comprise a variant having at least 90% sequence identity to wild-type lipase from Thermomyces lanuginosus and having sequence substitutions T231R and N233R.

The fabric may have been contacted with a lipid esterase at a concentration of between 30 and 55,000 ng enzyme/g fabric. The fabric may have been contacted with a lipid esterase at a concentration of between 30 and 2000 ng enzyme/g fabric. Alternatively, the fabric may have been contacted with a lipid esterase at a concentration of between 50 and 1700ng enzyme/g fabric, or even 80 and 1600 ng enzyme/g fabric. Alternatively, the fabric may have been contacted with a lipid esterase at a concentration of between 100 and 3000 ng enzyme/g fabric, or even 125 and 2500 ng enzyme/g fabric. Alternatively, the fabric may have been contacted with the lipid esterase at a concentration of between 100 and 35,000 ng enzyme/g fabric, or even between 500 and 30,000 ng enzyme/g fabric. Without wishing to be bound by theory, it is believed that these concentrations are optimal for soil removal from the fabrics.

The lipid esterase may be contacted in a previous wash operation and the fabric subsequently dried. The lipid esterase may have been previously deposited by washing the fabric in a wash liquor comprising the lipid esterase. For example the lipid esterase may be formed in a wash cycle of a machine wash operation. Alternatively, the lipid esterase may have been added to the fabric in the form of a pre-treater. For example it may have been deposited as a pre-treat stain remover composition. In this aspect, the pre-treat composition is added to a portion or all of the fabric at some point before it is subjected to a wash operation. Alternatively, the pre-treat composition is added to a specific stain on the fabric at some point before the fabric is subjected to a wash operation. Alternatively, the lipid esterase may have been contacted to the fabric during fabric manufacture.

The lipid esterase in step (i) can be used in combination with any other known laundry detergent ingredients detailed below.

### Step (ii)

The present invention comprises a step (ii) of contacting the fabric from step (i) with a cationically charged fabric softening active, wherein the cationically charged fabric softening active comprises a substrate for the lipid esterase.

The cationically charged fabric softening active may be present in a laundry treatment composition. The laundry treatment composition may be in any suitable form including granular, liquid or unitized dose. When in unitized dose form, it is preferred that the laundry treatment composition is enclosed with a water-soluble film, for example a polyvinyl alcohol-based film.

In the context of the present invention, the lipid esterase is believed to hydrolyse esters present in the cationically charged fabric softening active. Thus, the fabric softening active must comprise a substrate for the lipid esterase.

Preferably, the fabric softener active comprises an active selected from the group comprising, diester quaternary ammonium compounds, dialkyl quaternary ammonium compounds, imidazolinium quaternary compounds, cationic starch, sucrose ester-based fabric care materials, and mixtures thereof.

In one aspect, said ester quat fabric softener active, monoester, diester, and triester quat fabric softener active and ion pair fabric softener actives are selected from the group consisting of:
a) materials having Formula (1) below

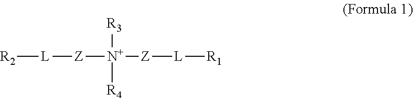

wherein:
   (i) R₁ and R₂ are each independently a C₅-C₂₃ hydrocarbon;
   (ii) R₃ and R₄ are each independently selected from the group consisting of C₁-C₄ hydrocarbon, C₁-C₄ hydroxy substituted hydrocarbon, benzyl, —(C₂H₄O)_{y}H where y is an integer from 1 to 10;
   (iii) L is selected from the group consisting of —C(O)O—, —OC(O)—;
   (iv) Z is selected from the group consisting of —(CH₂)ₙ, —CH₂C(CH₃)H— where each n is independently an integer from 1 to 4
   (v) X⁻ is a softener-compatible anion;
b) materials having Formula (2) below

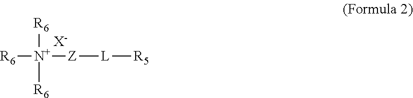

wherein
   (i) R₅ is a C₅-C₂₃ hydrocarbon;
   (ii) each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
   (iii) L is selected from the group consisting of —C(O)O—, —O—(O)C—,
   (iv) Z is selected from the group consisting of —(CH₂)ₙ, —CH₂C(CH₃)H— where each n is independently an integer from 1 to 4;
   (v) X⁻ is a softener-compatible anion;
c) materials having Formula (3) below

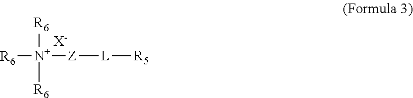

wherein
   (i) R₅ is a C₅-C₂₃ hydrocarbon;
   (ii) each R₆ is independently selected from the group consisting of C₁-C₄ hydrocarbon, Cᵢ-C₄ hydroxy substituted hydrocarbon, benzyl, —(C₂H₄O)_{y}H where y is an integer from 1 to 10;
   (iii) L is selected from the group consisting of —C(O)O—, —O—(O)C—,
   (iv) Z is selected from the group consisting of —(CH₂)ₙ, —CH₂C(CH₃)H— where each n is independently an integer from 1 to 4;
   (v) X⁻ is an anionic surfactant comprising a C₆-C₂₄ hydrocarbon.
d) materials having Formula (4) below

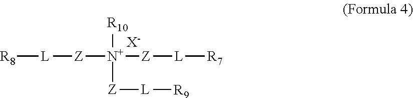

wherein:
   (i) R₇, R₈ and R₉ are each independently a C₅-C₂₃ hydrocarbon;
   (i) R₁₀ is selected from the group consisting of C₁-C₄ hydrocarbon, C₁-C₄ hydroxy substituted hydrocarbon, benzyl, —(C₂H₄O)_{y}H where y is an integer from 1 to 10;
   (ii) L is selected from the group consisting of —C(O)O—, —O—(O)C—;
   (iii) Z is selected from the group consisting of —(CH₂)ₙ, —CH₂C(CH₃)H— where each n is independently an integer from 1 to 4;
   (iv) X⁻ is a softener-compatible anion;

In one aspect, said di-tail fabric softener active, mono-tail fabric softener active and ion pair fabric softener actives are selected from the group consisting of:
a) materials having Formula (1) below

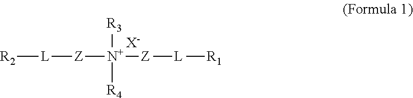

wherein:
   (i) R₁ and R₂ are each independently a C₁₁-C₁₇ hydrocarbon;
   (ii) R₃ and R₄ are each independently selected from the group consisting of C₁-C₂ hydrocarbon, C₁-C₂ hydroxy substituted hydrocarbon;
   (iii) Z is selected from the group consisting of —(CH₂)ₙ, —CH₂C(CH₃)H— where each n is independently an integer from 1 to 2;
   (iv) L is selected from the group consisting of —C(O)O—, —O—(O)C—;
   (v) X— is a softener-compatible anion, selected from the group consisting of halides, sulfonates, sulfates, and nitrates.
b) materials having Formula (2) below

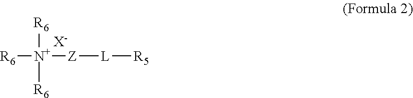

wherein
(i) R₅ is a C₁₁-C₁₇ hydrocarbon;
   (ii) each R₆ is independently selected from the group consisting of C₁-C₂ hydrocarbon, C₁-C₂ hydroxy substituted hydrocarbon;
   (iii) Z is selected from the group consisting of —(CH₂)ₙ, —CH₂C(CH₃)H— where each n is independently an integer from 1 to 4;
   (iv) L is selected from the group consisting of —C(O)O—, —O—(O)C—;
   (v) X⁻ is a softener-compatible anion, selected from the group consisting of halides, sulfonates, sulfates, and nitrates;
c) materials having Formula (3) below

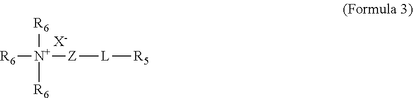

wherein
   (i) R₅ is a C₁₁-C₁₇ hydrocarbon;
   (ii) each R₆ is independently selected from the group consisting of C₁-C₄ hydrocarbon, C₁-C₄ hydroxy substituted hydrocarbon, benzyl, —(C₂H₄O)_{y}H where y is an integer from 1 to 10;
   (iii) L is selected from the group consisting of —C(O)O—, —O—(O)C—;
   (iv) Z is selected from the group consisting of —(CH₂)ₙ, —CH₂C(CH₃)H— where each n is independently an integer from 1 to 4;
   (v) X— is an anionic surfactant comprising a C₆-C₂₄ hydrocarbon.

In one aspect, said di-tail fabric softener active, mono-tail fabric softener active and ion pair fabric softener actives are selected from the group consisting of:
b) materials having Formula (1) below

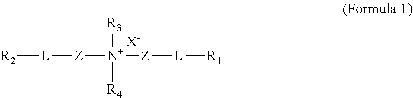

wherein:
   (i) R₁ and R₂ are each independently a C₁₁-C₁₇ hydrocarbon;
   (ii) R₃ and R₄ are each independently selected from the group consisting of C₁-C₂ hydrocarbon, C₁-C₂ hydroxy substituted hydrocarbon; (iii) Z is selected from the group consisting of —(CH₂)ₙ, —CH₂C(CH₃)H— where each n is independently an integer from 1 to 2;
   (iv) L is selected from the group consisting of —C(O)O—, —O—(O)C—;
   (v) X⁻ is a softener-compatible anion, selected from the group consisting of chloride, bromide, methylsulfate, ethylsulfate, and methyl sulfonate.
b) materials having Formula (2) below

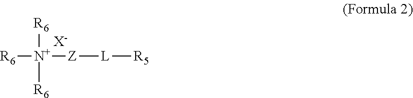

wherein
   (i) R₅ is a C₁₁-C₁₇ hydrocarbon;
   (ii) each R₆ is independently selected from the group consisting of C₁-C₂ hydrocarbon, C₁-C₂ hydroxy substituted hydrocarbon;
   (iii) Z is selected from the group consisting of —(CH₂)ₙ, —CH₂C(CH₃)H— where each n is independently an integer from 1 to 4;
   (iv) L is selected from the group consisting of —C(O)O—, —O—(O)C—;
   (v) X— is a softener-compatible anion, selected from the group consisting of chloride, bromide, methylsulfate, ethylsulfate, and methyl sulfonate or anionic surfactant comprising a C₆-C₁₈ hydrocarbon
c) materials having Formula (3) below

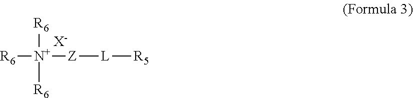

wherein
   (i) R₅ is a C₁₁-C₁₇ hydrocarbon;
   (ii) each R₆ is independently selected from the group consisting of C₁-C₂ hydrocarbon, C₁-C₂ hydroxy substituted hydrocarbon;
   (iii) Z is selected from the group consisting of —(CH₂)ₙ, —CH₂C(CH₃)H— where each n is independently an integer from 1 to 4;
   (iv) L is selected from the group consisting of —C(O)O—, —O—(O)C—;
   (v) X— is a softener-compatible anion, selected from the group consisting of chloride, bromide, methylsulfate, ethylsulfate, and methyl sulfonate or anionic surfactant comprising a C₆-C₁₈ hydrocarbon.

In one aspect, for Formula 2, X— is a C₆-C₂₄ hydrocarbon that is an anionic surfactant.

In one aspect, said fabric care active comprises a fabric softening active selected from the group consisting of N,N-di(hydrogenated tallowoyloxyethyl)-N,N-dimethylammonium chloride; N,N-di(tallowoyloxyethyl)-N,N-dimethylammonium chloride; N,N-di(hydrogenated tallowoyloxyisopropyl)-N,N-dimethylammonium chloride; N,N-di(tallowoyloxyisopropyl)-N,N-dimethylammonium chloride; N,N-di(stearoyloxyisopropyl)-N,N-dimethylammonium chloride; N,N-di(palmoyloxyisopropyl)-N,N-dimethylammonium chloride; bis-(2-hydroxypropyl)-dimethylammonium chloride stearic acid diester; partially hydrogenated bis-(2-hydroxypropyl)-dimethylammonium chloride palmitic acid diester; and mixtures thereof.

In the cationic nitrogenous salts herein, the anion A⁻, which is any softener compatible anion, provides electrical neutrality. Most often, the anion used to provide electrical neutrality in these salts is from a strong acid, especially a halide, such as chloride, bromide, or iodide. However, other anions can be used, such as methylsulfate, ethylsulfate, acetate, formate, sulfate, carbonate, and the like. Chloride and methylsulfate are preferred herein as anion A. The anion can also, but less preferably, carry a double charge in which case A⁻ represents half a group.

It was surprisingly found that deposition of the lipid esterase onto the fabric was improved wherein the fabric had been previously been treated with a cationically charged fabric softening active.

Step (iii)

The present invention comprises a step (iii) of contacting the fabric from step (ii) with a laundry detergent composition, wherein the laundry detergent composition comprises an anionic detersive surfactant, wherein the anionic detersive surfactant is present at the ratio of anionic surfactant to fabric on a weight to weight basis of from 1:150 to 1:500.

The composition may be in any suitable form including granular, liquid or unitized dose. When in unitized dose form, it is preferred that the composition is enclosed with a water-soluble film, for example a polyvinyl alcohol-based film.

The fabric may be contacted with the composition in step (iii) in the form of a wash liquor, or even a wash liquor in a machine wash cycle. Alternatively, the fabric may be contacted with the composition in the form of a wash pre-treat composition. In this aspect, the pre-treat composition is added to a portion or all of the fabric at some point before it is contacted with a wash liquor. Alternatively, the pre-treat composition may be added to a specific stain on the fabric at some point before the fabric is contacted with a wash liquor.

The fabric may be contacted with the composition in step (iii) at a temperature of 60° C. or less, or even 40° C. or less. The fabric may be contacted with the composition at a temperature of between 5° C. and 50° C., preferably between 10° C. and 30° C. The fabric may be contacted at these temperatures in the wash cycle of a domestic washing machine.

The fabric may be contacted with a laundry detergent composition in step (iii) in a wash cycle of an automatic washing machine and the length of the wash cycle may be at least 30 seconds, or even at least 3 mins, or even at least 6 mins, but no more than 30 mins, or even no more than 45 mins, or even no more than 1 hour.

The laundry detergent composition comprises an anionic detersive surfactant. Suitable anionic detersive surfactants include linear alkyl benzene sulfonate, alkoxylated anionic surfactant, or a combination thereof. Suitable anionic detersive surfactants include sulphate and sulphonate detersive surfactants.

Suitable sulphonate detersive surfactants include alkyl benzene sulphonate, such as C₁₀₋₁₃ alkyl benzene sulphonate. Suitable alkyl benzene sulphonate (LAS) is obtainable, or even obtained, by sulphonating commercially available linear alkyl benzene (LAB); suitable LAB includes low 2-phenyl LAB, such as those supplied by Sasol under the tradename Isochem® or those supplied by Petresa under the tradename Petrelab®, other suitable LAB include high 2-phenyl LAB, such as those supplied by Sasol under the tradename Hyblene®. Another suitable anionic detersive surfactant is alkyl benzene sulphonate that is obtained by DETAL catalyzed process, although other synthesis routes, such as HF, may also be suitable.

Suitable sulphate detersive surfactants include alkyl sulphate, such as C₈₋₁₈ alkyl sulphate, or predominantly C₁₂ alkyl sulphate. The alkyl sulphate may be derived from natural sources, such as coco and/or tallow. Alternative, the alkyl sulphate may be derived from synthetic sources such as C₁₂₋₁₅ alkyl sulphate.

Another suitable sulphate detersive surfactant is alkyl alkoxylated sulphate, such as alkyl ethoxylated sulphate, or a C₈₋₁₈ alkyl alkoxylated sulphate, or a C₈₋₁₈ alkyl ethoxylated sulphate. The alkyl alkoxylated sulphate may have an average degree of alkoxylation of from 0.5 to 20, or from 0.5 to 10. The alkyl alkoxylated sulphate may be a C₈₋₁₈ alkyl ethoxylated sulphate, typically having an average degree of ethoxylation of from 0.5 to 10, or from 0.5 to 7, or from 0.5 to 5 or from 0.5 to 3.

The alkyl sulphate, alkyl alkoxylated sulphate and alkyl benzene sulphonates may be linear or branched, substituted or un-substituted.

The anionic detersive surfactant may be a mid-chain branched anionic detersive surfactant, such as a mid-chain branched alkyl sulphate and/or a mid-chain branched alkyl benzene sulphonate. The mid-chain branches are typically C₁₋₄ alkyl groups, such as methyl and/or ethyl groups.

Another suitable anionic detersive surfactant is alkyl ethoxy carboxylate.

The anionic detersive surfactants are typically present in their salt form, typically being complexed with a suitable cation. Suitable counter-ions include Na⁺ and K⁺, substituted ammonium such as C₁-C₆ alkanolammnonium such as mono-ethanolamine (MEA) tri-ethanolamine (TEA), di-ethanolamine (DEA), and any mixture thereof.

The detersive surfactant may comprise linear alkylbenzene sulfonate and a co-surfactant, wherein, the co-surfactant is selected from a non-ionic surfactant, an alkoxylated anionic surfactant, or a combination thereof. Suitable alkoxylated anionic surfactants are described above. Suitable non-ionic detersive surfactants are selected from the group consisting of: C₈-C₁₈ alkyl ethoxylates, such as, NEODOL® non-ionic surfactants from Shell; C₆-C₁₂ alkyl phenol alkoxylates wherein optionally the alkoxylate units are ethyleneoxy units, propyleneoxy units or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols; C₁₄-C₂₂ mid-chain branched alkyl alkoxylates, typically having an average degree of alkoxylation of from 1 to 30; alkylpolysaccharides, such as alkylpolyglycosides; polyhydroxy fatty acid amides; ether capped poly(oxyalkylated) alcohol surfactants; and mixtures thereof.

The anionic detersive surfactant is present at the ratio of anionic surfactant to fabric on a weight to weight basis of from 1:150 to 1:500, or even from 1:200 to 1:500, or even from 1:300 to 1:500.

The laundry detergent composition in step (iii) may also comprise a lipid esterase. Suitable lipid esterases are as detailed above.

### Other Ingredients

The laundry detergent composition of step (iii) may comprise further laundry detergent ingredients. The laundry detergent composition of step (iii) may comprise a hueing agent, a polymer or a combination thereof. Suitable detergent ingredients include: hueing agent; detersive surfactants including anionic detersive surfactants, non-ionic detersive surfactants, cationic detersive surfactants, zwitterionic detersive surfactants, amphoteric detersive surfactants, and any combination thereof; polymers including carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof; builders including zeolites, phosphates, citrate, and any combination thereof; buffers and alkalinity sources including carbonate salts and/or silicate salts; fillers including sulphate salts and bio-filler materials; bleach including bleach activators, sources of available oxygen, pre-formed peracids, bleach catalysts, reducing bleach, and any combination thereof; chelants;

photobleach; hueing agents; brighteners; enzymes including proteases, amylases, cellulases, lipases, xylogucanases, pectate lyases, mannanases, bleaching enzymes, cutinases, and any combination thereof; fabric softeners including clay, silicones, quaternary ammonium fabric-softening agents, and any combination thereof; flocculants such as polyethylene oxide; perfume including starch encapsulated perfume accords, perfume microcapsules, perfume loaded zeolites, schif base reaction products of ketone perfume raw materials and polyamines, blooming perfumes, and any combination thereof; aesthetics including soap rings, lamellar aesthetic particles, geltin beads, carbonate and/or sulphate salt speckles, coloured clay, and any combination thereof: and any combination thereof.

Fabric Hueing Agents—The composition may comprise a fabric hueing agent (sometimes referred to as shading, bluing or whitening agents). Typically the hueing agent provides a blue or violet shade to fabric. Hueing agents can be used either alone or in combination to create a specific shade of hueing and/or to shade different fabric types. This may be provided for example by mixing a red and green-blue dye to yield a blue or violet shade. Hueing agents may be selected from any known chemical class of dye, including but not limited to acridine, anthraquinone (including polycyclic quinones), azine, azo (e.g., monoazo, disazo, trisazo, tetrakisazo, polyazo), including premetallized azo, benzodifurane and benzodifuranone, carotenoid, coumarin, cyanine, diazahemicyanine, diphenylmethane, formazan, hemicyanine, indigoids, methane, naphthalimides, naphthoquinone, nitro and nitroso, oxazine, phthalocyanine, pyrazoles, stilbene, styryl, triarylmethane, triphenylmethane, xanthenes and mixtures thereof. Suitable fabric hueing agents include dyes, dye-clay conjugates, and organic and inorganic pigments. Suitable dyes include small molecule dyes and polymeric dyes. Suitable small molecule dyes include small molecule dyes selected from the group consisting of dyes falling into the Colour Index (C.I.) classifications of Acid, Direct, Basic, Reactive or hydrolysed Reactive, Solvent or Disperse dyes for example that are classified as Blue, Violet, Red, Green or Black, and provide the desired shade either alone or in combination. In another aspect, suitable small molecule dyes include small molecule dyes selected from the group consisting of Colour

Index (Society of Dyers and Colourists, Bradford, UK) numbers Direct Violet dyes such as 9, 35, 48, 51, 66, and 99, Direct Blue dyes such as 1, 71, 80 and 279, Acid Red dyes such as 17, 73, 52, 88 and 150, Acid Violet dyes such as 15, 17, 24, 43, 49 and 50, Acid Blue dyes such as 15, 17, 25, 29, 40, 45, 75, 80, 83, 90 and 113, Acid Black dyes such as 1, Basic Violet dyes such as 1, 3, 4, 10 and 35, Basic Blue dyes such as 3, 16, 22, 47, 66, 75 and 159, Disperse or Solvent dyes such as those described in US 2008/034511 A1 or U.S. Pat. No. 8,268,016 B2, or dyes as disclosed in U.S. Pat. No. 7,208,459 B2, and mixtures thereof. In another aspect, suitable small molecule dyes include small molecule dyes selected from the group consisting of C. I. numbers Acid Violet 17, Direct Blue 71, Direct Violet 51, Direct Blue 1, Acid Red 88, Acid Red 150, Acid Blue 29, Acid Blue 113 or mixtures thereof.

Preferred dyes include dye polymers, wherein a dye group is bound to a polymeric group, optionally via a linking group. Suitable polymeric groups include (1) alkoxylated polyethyleneimine (for example as disclosed in WO2012119859), (2) polyvinyl alcohol (for example as disclosed in WO2012130492), or (3) diamine derivative of an alkylene oxide capped polyethylene glycol (for example as disclosed in WO2012126665, especially FIG. 24), or polyalkoxylated alcohol, for example as described in WO2011/011799, WO2012/054058, WO2012/166699 or WO2012/166768. One preferred class of dye polymers is obtainable by reacting a blue or violet dye containing an NH2 group with a polymer to form a covalent bond via the reacted NH2 group of the blue or violet dye and the dye polymer has an average of from 0 to 30, preferably 2 to 20, most preferably 2 to 15 repeating same units. In a preferred embodiment the monomeric units are selected from alkylene oxides, preferably ethylene oxides. Typically dye polymers will be in the form of a mixture of dye polymers in which there is a mixture of molecules having a distribution of number of monomer groups in the polymer chains, such as the mixture directly produced by the appropriate organic synthesis route, for example in the case of alkylene oxide polymers, the result of an alkoxylation reaction. Such dye polymers are typically blue or violet in colour, to give to the cloth a hue angle of 230 to 345, more preferably 250 to 330, most preferably 270 to 300. In the synthesis of dye polymers unbound blue or violet organic dyes may be present in a mixture with the final dye-polymer product. The chromophore of the blue or violet dye is preferably selected from the group consisting of: azo; anthraquinone; phthalocyanine; triphendioxazine; and, triphenylmethane. In one aspect the dye polymer is obtainable by reacting a dye containing an NH[2] group with a polymer or suitable monomer that forms a polymer in situ. Preferably the NH[2] is covalently bound to an aromatic ring of the dye. Unbound dye is formed when the dye does not react with polymer. Preferred dyes containing -NH[2] groups for such reactions are selected from: acid violet 1; acid violet 3; acid violet 6; acid violet 11; acid violet 13; acid violet 14; acid violet 19; acid violet 20; acid violet 36; acid violet 36:1; acid violet 41; acid violet 42; acid violet 43; acid violet 50; acid violet 51; acid violet 63; acid violet 48; acid blue 25; acid blue 40; acid blue 40:1; acid blue 41; acid blue 45; acid blue 47; acid blue 49; acid blue 51 ; acid blue 53; acid blue 56; acid blue 61; acid blue 61:1; acid blue 62; acid blue 69; acid blue 78; acid blue 81:1; acid blue 92; acid blue 96; acid blue 108; acid blue 111; acid blue 215; acid blue 230; acid blue 277; acid blue 344; acid blue 117; acid blue 124; acid blue 129; acid blue 129:1; acid blue 138; acid blue 145; direct violet 99; direct violet 5; direct violet 72; direct violet 16; direct violet 78; direct violet 77; direct violet 83; food black 2; direct blue 33; direct blue 41; direct blue 22; direct blue 71; direct blue 72; direct blue 74; direct blue 75; direct blue 82; direct blue 96; direct blue 110; direct blue 111; direct blue 120; direct blue 120:1 ; direct blue 121; direct blue 122; direct blue 123; direct blue 124; direct blue 126; direct blue 127; direct blue 128; direct blue 129; direct blue 130; direct blue 132; direct blue 133; direct blue 135; direct blue 138; direct blue 140; direct blue 145; direct blue 148; direct blue 149; direct blue 159; direct blue 162; direct blue 163; food black 2; food black 1 wherein the acid amide group is replaced by NH[2]; Basic Violet 2; Basic Violet 5; Basic Violet 12; Basic Violet 14; Basic Violet 8; Basic Blue 12; Basic Blue 16; Basic Blue 17; Basic Blue 47; Basic Blue 99; disperse blue 1; disperse blue 5; disperse blue 6; disperse blue 9; disperse blue 11; disperse blue 19; disperse blue 20; disperse blue 28; disperse blue 40; disperse blue 56; disperse blue 60; disperse blue 81; disperse blue 83; disperse blue 87; disperse blue 104; disperse blue 118; disperse violet 1; disperse violet 4, disperse violet 8, disperse violet 17, disperse violet 26; disperse violet 28; solvent violet 26; solvent blue 12; solvent blue 13; solvent blue 18; solvent blue 68. Further preferred dyes are selected from mono-azo dyes which contain a phenyl group directly attached to the azo group, wherein the phenyl group has an NH[2] groups covalent bound to it. For example a mono-azo thiophene dye. The polymer chain may be selected from polyalkylene oxides. The polymer chain andf/or the dye chromophore group may optionally carry anionic or cationic groups. Examples of polyoxyalkylene oxide chains include ethylene oxide, propylene oxide, glycidol oxide, butylene oxide and mixtures thereof.

Suitable polymeric dyes include polymeric dyes selected from the group consisting of polymers containing covalently bound (sometimes referred to as conjugated) chromogens, (dye-polymer conjugates), for example polymers with chromogens co-polymerized into the backbone of the polymer and mixtures thereof. Polymeric dyes include those described in WO2011/98355, US 2012/225803 A1, US 2012/090102 A1, U.S. Pat. No. 7,686,892 B2, and WO2010/142503.

In another aspect, suitable polymeric dyes include polymeric dyes selected from the group consisting of fabric-substantive colorants sold under the name of Liquitint® (Milliken, Spartanburg, S.C., USA), dye-polymer conjugates formed from at least one reactive dye and a polymer selected from the group consisting of polymers comprising a moiety selected from the group consisting of a hydroxyl moiety, a primary amine moiety, a secondary amine moiety, a thiol moiety and mixtures thereof. In still another aspect, suitable polymeric dyes include polymeric dyes selected from the group consisting of Liquitint® Violet CT, carboxymethyl cellulose (CMC) covalently bound to a reactive blue, reactive violet or reactive red dye such as CMC conjugated with C.I. Reactive Blue 19, sold by Megazyme, Wicklow, Ireland under the product name AZO-CM-CELLULOSE, product code S-ACMC, alkoxylated triphenyl-methane polymeric colourants, alkoxylated thiophene polymeric colourants, and mixtures thereof.

Preferred hueing dyes include the whitening agents found in WO 08/87497 A1, WO2011/011799 and US 2012/129752 A1. Preferred hueing agents for use in the present invention may be the preferred dyes disclosed in these references, including those selected from Examples 1-42 in Table 5 of WO2011/011799. Other preferred dyes are disclosed in U.S. Pat. No. 8,138,222B2, especially claim 1 of U.S. Pat. No. 8,138,222B2. Other preferred dyes are disclosed in U.S. Pat. No. 7,909,890 B2.

Suitable dye clay conjugates include dye clay conjugates selected from the group comprising at least one cationic/basic dye and a smectite clay, and mixtures thereof. In another aspect, suitable dye clay conjugates include dye clay conjugates selected from the group consisting of one cationic/basic dye selected from the group consisting of C.I. Basic Yellow 1 through 108, C.I. Basic Orange 1 through 69, C.I. Basic Red 1 through 118, C.I. Basic Violet 1 through 51, C.I. Basic Blue 1 through 164, C.I. Basic Green 1 through 14, C.I. Basic Brown 1 through 23, CI Basic Black 1 through 11, and a clay selected from the group consisting of Montmorillonite clay, Hectorite clay, Saponite clay and mixtures thereof. In still another aspect, suitable dye clay conjugates include dye clay conjugates selected from the group consisting of: Montmorillonite Basic Blue B7 C.I. 42595 conjugate, Montmorillonite Basic Blue B9 C.I. 52015 conjugate, Montmorillonite Basic Violet V3 C.I. 42555 conjugate, Montmorillonite Basic Green G1 C.I. 42040 conjugate, Montmorillonite Basic Red R1 C.I. 45160 conjugate, Montmorillonite C.I. Basic Black 2 conjugate, Hectorite Basic Blue B7 C.I. 42595 conjugate, Hectorite Basic Blue B9 C.I. 52015 conjugate, Hectorite Basic Violet V3 C.I. 42555 conjugate, Hectorite Basic Green G1 C.I. 42040 conjugate, Hectorite Basic Red R1 C.I. 45160 conjugate, Hectorite C.I. Basic Black 2 conjugate, Saponite Basic Blue B7 C.I. 42595 conjugate, Saponite Basic Blue B9 C.I. 52015 conjugate, Saponite Basic Violet V3 C.I. 42555 conjugate, Saponite Basic Green G1 C.I. 42040 conjugate, Saponite Basic Red R1 C.I. 45160 conjugate, Saponite C.I. Basic Black 2 conjugate and mixtures thereof.

Suitable pigments include pigments selected from the group consisting of flavanthrone, indanthrone, chlorinated indanthrone containing from 1 to 4 chlorine atoms, pyranthrone, dichloropyranthrone, monobromodichloropyranthrone, dibromodichloropyranthrone, tetrabromopyranthrone, perylene-3,4,9,10-tetracarboxylic acid diimide, wherein the imide groups may be unsubstituted or substituted by C1-C3-alkyl or a phenyl or heterocyclic radical, and wherein the phenyl and heterocyclic radicals may additionally carry substituents which do not confer solubility in water, anthrapyrimidinecarboxylic acid amides, violanthrone, isoviolanthrone, dioxazine pigments, copper phthalocyanine which may contain up to 2 chlorine atoms per molecule, polychloro-copper phthalocyanine or polybromochloro-copper phthalocyanine containing up to 14 bromine atoms per molecule and mixtures thereof.

In another aspect, suitable pigments include pigments selected from the group consisting of Ultramarine Blue (C.I. Pigment Blue 29), Ultramarine Violet (C.I. Pigment Violet 15) and mixtures thereof.

The aforementioned fabric hueing agents can be used in combination (any mixture of fabric hueing agents can be used).

Polymer: Suitable polymers include carboxylate polymers, polyethylene glycol polymers, polyester soil release polymers such as terephthalate polymers, amine polymers, cellulosic polymers, dye transfer inhibition polymers, dye lock polymers such as a condensation oligomer produced by condensation of imidazole and epichlorhydrin, optionally in ratio of 1:4:1, hexamethylenediamine derivative polymers, and any combination thereof.

Carboxylate polymer: Suitable carboxylate polymers include maleate/acrylate random copolymer or polyacrylate homopolymer. The carboxylate polymer may be a polyacrylate homopolymer having a molecular weight of from 4,000 Da to 9,000 Da, or from 6,000 Da to 9,000 Da. Other suitable carboxylate polymers are co-polymers of maleic acid and acrylic acid, and may have a molecular weight in the range of from 4,000 Da to 90,000 Da.

Other suitable carboxylate polymers are co-polymers comprising: (i) from 50 to less than 98 wt % structural units derived from one or more monomers comprising carboxyl groups; (ii) from 1 to less than 49 wt % structural units derived from one or more monomers comprising sulfonate moieties; and (iii) from 1 to 49 wt % structural units derived from one or more types of monomers selected from ether bond-containing monomers represented by formulas (I) and (II):

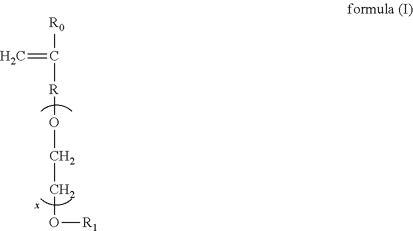

wherein in formula (I), R₀ represents a hydrogen atom or CH₃ group, R represents a CH₂ group, CH₂CH₂ group or single bond, X represents a number 0-5 provided X represents a number 1-5 when R is a single bond, and R₁ is a hydrogen atom or C₁ to C₂₀ organic group;

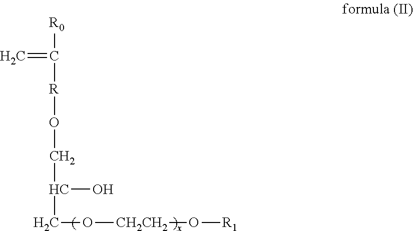

in formula (II), R₀ represents a hydrogen atom or CH₃ group, R represents a CH₂ group, CH₂CH₂ group or single bond, X represents a number 0-5, and R₁ is a hydrogen atom or C₁ to C₂₀ organic group.

Polyethylene glycol polymer: Suitable polyethylene glycol polymers include random graft co-polymers comprising: (i) hydrophilic backbone comprising polyethylene glycol; and (ii) hydrophobic side chain(s) selected from the group consisting of: C₄₋C₂₅ alkyl group, polypropylene, polybutylene, vinyl ester of a saturated C₁-C₆ mono-carboxylic acid, C₁₋C₆ alkyl ester of acrylic or methacrylic acid, and mixtures thereof. Suitable polyethylene glycol polymers have a polyethylene glycol backbone with random grafted polyvinyl acetate side chains. The average molecular weight of the polyethylene glycol backbone can be in the range of from 2,000 Da to 20,000 Da, or from 4,000 Da to 8,000 Da. The molecular weight ratio of the polyethylene glycol backbone to the polyvinyl acetate side chains can be in the range of from 1:1 to 1:5, or from 1:1.2 to 1:2. The average number of graft sites per ethylene oxide units can be less than 1, or less than 0.8, the average number of graft sites per ethylene oxide units can be in the range of from 0.5 to 0.9, or the average number of graft sites per ethylene oxide units can be in the range of from 0.1 to 0.5, or from 0.2 to 0.4. A suitable polyethylene glycol polymer is Sokalan HP22.

Polyester soil release polymers: Suitable polyester soil release polymers have a structure as defined by one of the following structures (I), (II) or (III):

(I) —[(OCHR¹—CHR²)ₐ—O—OC—Ar—CO—]_{d}

(II) —[(OCHR³—CHR⁴)_{b}—O—OC-sAR—CO—]ₑ

(III) —[(OCHR⁵—CHR⁶)_{c}—OR⁷]_{f}

wherein:

a, b and c are from 1 to 200;

d, e and f are from 1 to 50;

Ar is a 1,4-substituted phenylene;

sAr is 1,3-substituted phenylene substituted in position 5 with SO₃Me;

Me is H, Na, Li, K, Mg/2, Ca/2, Al/3, ammonium, mono-, di-, tri-, or tetraalkylammonium wherein the alkyl groups are C₁-C₁₈ alkyl or C₂-C₁₀ hydroxyalkyl, or any mixture thereof;

R¹, R², R³, R⁴, R⁵ and R⁶ are independently selected from H or C₁-C₁₈ n- or iso-alkyl; and

R⁷ is a linear or branched C₁-C₁₈ alkyl, or a linear or branched C₂-C₃₀ alkenyl, or a cycloalkyl group with 5 to 9 carbon atoms, or a C₈-C₃₀ aryl group, or a C₆-C₃₀ arylalkyl group. Suitable polyester soil release polymers are terephthalate polymers having the structure of formula (I) or (II) above.

Suitable polyester soil release polymers include the Repel-o-tex series of polymers such as Repel-o-tex SF2 (Rhodia) and/or the Texcare series of polymers such as Texcare SRA300 (Clariant).

Amine polymer: Suitable amine polymers include polyethylene imine polymers, such as alkoxylated polyalkyleneimines, optionally comprising a polyethylene and/or polypropylene oxide block.

Cellulosic polymer: The composition can comprise cellulosic polymers, such as polymers selected from alkyl cellulose, alkyl alkoxyalkyl cellulose, carboxyalkyl cellulose, alkyl carboxyalkyl, and any combination thereof. Suitable cellulosic polymers are selected from carboxymethyl cellulose, methyl cellulose, methyl hydroxyethyl cellulose, methyl carboxymethyl cellulose, and mixtures thereof. The carboxymethyl cellulose can have a degree of carboxymethyl substitution from 0.5 to 0.9 and a molecular weight from 100,000 Da to 300,000 Da. Another suitable cellulosic polymer is hydrophobically modified carboxymethyl cellulose, such as Finnfix SH-1 (CP Kelco).

Other suitable cellulosic polymers may have a degree of substitution (DS) of from 0.01 to 0.99 and a degree of blockiness (DB) such that either DS+DB is of at least 1.00 or DB+2DS-DS² is at least 1.20. The substituted cellulosic polymer can have a degree of substitution (DS) of at least 0.55. The substituted cellulosic polymer can have a degree of blockiness (DB) of at least 0.35. The substituted cellulosic polymer can have a DS+DB, of from 1.05 to 2.00. A suitable substituted cellulosic polymer is carboxymethylcellulose.

Another suitable cellulosic polymer is cationically modified hydroxyethyl cellulose.

Dye transfer inhibitor (DTI) polymer: The laundry detergent compositions may comprise DTI polymers. Suitable DTIs include polyamine N-oxide polymers, copolymers of N-vinylpyrrolidone and N-vinylimidazole, polyvinylpyrrolidone polymers, polyvinyloxazolidones and polyvinylimidazoles or mixtures thereof. The DTI polymers discussed above are well known in the art and commercially available, for example PVP-K15 and K30 (Ashland), Sokalan HP165, HP50, HP53, HP59, HP56K, HP56, HP66 (BASF), Chromabond S-400, 5403E and S-100 (Ashland), and Polyquart FDI (Cognis).

Builder: Suitable builders include zeolites, phosphates, citrates, and any combination thereof.

Zeolite builder: The composition may be substantially free of zeolite builder. Substantially free of zeolite builder typically means comprises from 0 wt % to 10 wt %, zeolite builder, or to 8wt %, or to 6wt %, or to 4wt %, or to 3wt %, or to 2wt %, or even to 1 wt % zeolite builder. Substantially free of zeolite builder preferably means “no deliberately added” zeolite builder. Typical zeolite builders include zeolite A, zeolite P, zeolite MAP, zeolite X and zeolite Y.

Phosphate builder: The composition may be substantially free of phosphate builder. Substantially free of phosphate builder typically means comprises from 0 wt % to 10 wt % phosphate builder, or to 8wt %, or to 6wt %, or to 4wt %, or to 3wt %, or to 2wt %, or even to 1 wt % phosphate builder. Substantially free of zeolite builder preferably preferably means “no deliberately added” phosphate builder. A typical phosphate builder is sodium tri-polyphosphate (STPP).

Citrate: A suitable citrate is sodium citrate. However, citric acid may also be incorporated into the composition, which can form citrate in the wash liquor.

Buffer and alkalinity source: Suitable buffers and alkalinity sources include carbonate salts and/or silicate salts and/or double salts such as burkeitte.

Carbonate salt: A suitable carbonate salt is sodium carbonate and/or sodium bicarbonate. The carbonate salt may have a weight average mean particle size of from 100 to 500 micrometers. Alternatively, the carbonate salt may have a weight average mean particle size of from 10 to 25 micrometers.

Silicate salt: The silicate can be crystalline or amorphous. Suitable crystalline silicates include crystalline layered silicate, such as SKS-6. Other suitable silicates include 1.6R silicate and/or 2.0R silicate. A suitable silicate salt is sodium silicate. Another suitable silicate salt is sodium metasilicate.

Sulphate salt: A suitable sulphate salt is sodium sulphate. The sulphate salt may have a weight average mean particle size of from 100 to 500 micrometers, alternatively, the sulphate salt may have a weight average mean particle size of from 10 to 45 micrometers.

Bleach activator: Suitable bleach activators include: tetraacetylethylenediamine (TAED); oxybenzene sulphonates such as nonanoyl oxybenzene sulphonate (NOBS), caprylamidononanoyl oxybenzene sulphonate (NACA-OBS), 3,5,5-trimethyl hexanoyloxybenzene sulphonate (Iso-NOBS), dodecyl oxybenzene sulphonate (LOBS), and any mixture thereof; caprolactams; pentaacetate glucose (PAG); nitrile quaternary ammonium; imide bleach activators, such as N-nonanoyl-N-methyl acetamide; and any mixture thereof.

Source of available oxygen: A suitable source of available oxygen (AvOx) is a source of hydrogen peroxide, such as percarbonate salts and/or perborate salts, such as sodium percarbonate. The source of peroxygen may be at least partially coated, or even completely coated, by a coating ingredient such as a carbonate salt, a sulphate salt, a silicate salt, borosilicate, or any mixture thereof, including mixed salts thereof. Suitable percarbonate salts can be prepared by a fluid bed process or by a crystallization process. Suitable perborate salts include sodium perborate mono-hydrate (PB1), sodium perborate tetra-hydrate (PB4), and anhydrous sodium perborate which is also known as fizzing sodium perborate. Other suitable sources of AvOx include persulphate, such as oxone. Another suitable source of AvOx is hydrogen peroxide.

Pre-formed peracid: A suitable pre-formed peracid is N,N-pthaloylamino peroxycaproic acid (PAP).

Bleach catalyst: Suitable bleach catalysts include oxaziridinium-based bleach catalysts, transition metal bleach catalysts and bleaching enzymes.

Oxaziridinium-based bleach catalyst: A suitable oxaziridinium-based bleach catalyst has the formula:

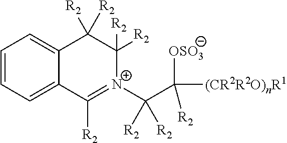

wherein: R¹ is selected from the group consisting of: H, a branched alkyl group containing from 3 to 24 carbons, and a linear alkyl group containing from 1 to 24 carbons; R¹ can be a branched alkyl group comprising from 6 to 18 carbons, or a linear alkyl group comprising from 5 to 18 carbons, R¹ can be selected from the group consisting of: 2-propylheptyl, 2-butyloctyl, 2-pentylnonyl, 2-hexyldecyl, n-hexyl, n-octyl, n-decyl, n-dodecyl, n-tetradecyl, n-hexadecyl, n-octadecyl, iso-nonyl, iso-decyl, iso-tridecyl and iso-pentadecyl; R² is independently selected from the group consisting of: H, a branched alkyl group comprising from 3 to 12 carbons, and a linear alkyl group comprising from 1 to 12 carbons; optionally R² is independently selected from H and methyl groups; and n is an integer from 0 to 1.

Transition metal bleach catalyst: The composition may include transition metal bleach catalyst, typically comprising copper, iron, titanium, ruthenium, tungsten, molybdenum, and/or manganese cations. Suitable transition metal bleach catalysts are manganese-based transition metal bleach catalysts.

Reducing bleach: The composition may comprise a reducing bleach. However, the composition may be substantially free of reducing bleach; substantially free means “no deliberately added”. Suitable reducing bleach include sodium sulphite and/or thiourea dioxide (TDO).

Co-bleach particle: The composition may comprise a co-bleach particle. Typically, the co-bleach particle comprises a bleach activator and a source of peroxide. It may be highly suitable for a large amount of bleach activator relative to the source of hydrogen peroxide to be present in the co-bleach particle. The weight ratio of bleach activator to source of hydrogen peroxide present in the co-bleach particle can be at least 0.3:1, or at least 0.6:1, or at least 0.7:1, or at least 0.8:1, or at least 0.9:1, or at least 1.0:1.0, or even at least 1.2:1 or higher.

The co-bleach particle can comprise: (i) bleach activator, such as TAED; and (ii) a source of hydrogen peroxide, such as sodium percarbonate. The bleach activator may at least partially, or even completely, enclose the source of hydrogen peroxide.

The co-bleach particle may comprise a binder. Suitable binders are carboxylate polymers such as polyacrylate polymers, and/or surfactants including non-ionic detersive surfactants and/or anionic detersive surfactants such as linear C₁₁-C₁₃ alkyl benzene sulphonate.

The co-bleach particle may comprise bleach catalyst, such as an oxaziridium-based bleach catalyst.

Chelant: Suitable chelants are selected from: diethylene triamine pentaacetate, diethylene triamine penta(methyl phosphonic acid), ethylene diamine-N′N′-disuccinic acid, ethylene diamine tetraacetate, ethylene diamine tetra(methylene phosphonic acid), hydroxyethane di(methylene phosphonic acid), and any combination thereof. A suitable chelant is ethylene diamine-N′N′-disuccinic acid (EDDS) and/or hydroxyethane diphosphonic acid (HEDP). The laundry detergent composition may comprise ethylene diamine-N′N′-disuccinic acid or salt thereof. The ethylene diamine-N′N′-disuccinic acid may be in S,S enantiomeric form. The composition may comprise 4,5-dihydroxy-m-benzenedisulfonic acid disodium salt. Suitable chelants may also be calcium crystal growth inhibitors.

Calcium carbonate crystal growth inhibitor: The composition may comprise a calcium carbonate crystal growth inhibitor, such as one selected from the group consisting of: 1-hydroxyethanediphosphonic acid (HEDP) and salts thereof; N,N-dicarboxymethyl-2-aminopentane-1,5-dioic acid and salts thereof; 2-phosphonobutane-1,2,4-tricarboxylic acid and salts thereof; and any combination thereof.

Photobleach: Suitable photobleaches are zinc and/or aluminium sulphonated phthalocyanines.

Brightener: The laundry detergent composition may comprise fluorescent brightener.

Preferred classes of fluorescent brightener are: Di-styryl biphenyl compounds, e.g. Tinopal™ CBS-X, Di-amino stilbene di-sulfonic acid compounds, e.g. Tinopal™ DMS pure Xtra and Blankophor™ HRH, and Pyrazoline compounds, e.g. Blankophor™ SN. Preferred fluorescers are: sodium 2 (4-styryl-3-sulfophenyl)-2H-napthol[1,2-d]triazole, disodium 4,4′-bis {[(4-anilino-6-(N methyl-N-2 hydroxyethyl)amino 1,3,5-triazin-2-yl)];amino}stilbene-2-2′ disulfonate, disodium 4,4′-bis {[(4-anilino-6-morpholino-1,3,5-triazin-2-yl)]amino}stilbene-2-2′ disulfonate, and disodium 4,4′-bis(2-sulfostyryl)biphenyl.

A particularly preferred fluorescent brightener is C.I. Fluorescent Brightener 260 having the following structure. For solid detergent compositions, this brightener may be used in its beta or alpha crystalline forms, or a mixture of these forms.

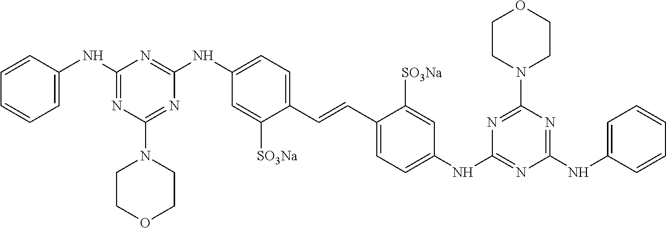

Enzyme: Suitable enzymes include proteases, amylases, cellulases, lipases, xylogucanases, pectate lyases, mannanases, bleaching enzymes, cutinases, and mixtures thereof.

For the enzymes, accession numbers and IDs shown in parentheses refer to the entry numbers in the databases Genbank, EMBL and/or Swiss-Prot. For any mutations, standard 1-letter amino acid codes are used with a * representing a deletion. Accession numbers prefixed with DSM refer to micro-organisms deposited at Deutsche Sammlung von Mikroorganismen and Zellkulturen GmbH, Mascheroder Weg 1b, 38124 Brunswick (DSMZ).

Protease. The composition may comprise a protease. Suitable proteases include metalloproteases and/or serine proteases, including neutral or alkaline microbial serine proteases, such as subtilisins (EC 3.4.21.62). Suitable proteases include those of animal, vegetable or microbial origin. In one aspect, such suitable protease may be of microbial origin. The suitable proteases include chemically or genetically modified mutants of the aforementioned suitable proteases. In one aspect, the suitable protease may be a serine protease, such as an alkaline microbial protease or/and a trypsin-type protease. Examples of suitable neutral or alkaline proteases include:

(a) subtilisins (EC 3.4.21.62), including those derived from Bacillus, such as Bacillus lentus, Bacillus alkalophilus (P27963, ELYA_BACAO), Bacillus subtilis, Bacillus amyloliquefaciens (P00782, SUBT_BACAM), Bacillus pumilus (P07518) and Bacillus gibsonii (DSM14391).

(b) trypsin-type or chymotrypsin-type proteases, such as trypsin (e.g. of porcine or bovine origin), including the Fusarium protease and the chymotrypsin proteases derived from Cellumonas (A2RQE2).

(c) metalloproteases, including those derived from Bacillus amyloliquefaciens (P06832, NPRE_BACAM).

Suitable proteases include those derived from Bacillus gibsonii or Bacillus Lentus such as subtilisin 309 (P29600) and/or DSM 5483 (P29599).

Suitable commercially available protease enzymes include: those sold under the trade names Alcalase®, Savinase®, Primase®, Durazym®, Polarzyme®, Kannase®, Liquanase®, Liquanase Ultra®, Savinase Ultra®, Ovozyme®, Neutrase®, Everlase® and Esperase® by Novozymes A/S (Denmark); those sold under the tradename Maxatase®, Maxacal®, Maxapem®, Properase®, Purafect®, Purafect Prime®, Purafect Ox®, FN3® , FN4®, Excellase® and Purafect OXP® by Genencor International; those sold under the tradename Opticlean® and Optimase® by Solvay Enzymes; those available from Henkel/Kemira, namely BLAP (P29599 having the following mutations S99D+S101 R+S103A+V104I+G159S), and variants thereof including BLAP R (BLAP with S3T+V4I+V199M+V205I+L217D), BLAP X (BLAP with S3T+V4I+V205I) and BLAP F49 (BLAP with S3T+V4I+A194P+V199M+V205I+L217D) all from Henkel/Kemira; and KAP (Bacillus alkalophilus subtilisin with mutations A230V+S256G+S259N) from Kao.

Other suitable protease enzymes are fungal serine proteases. Suitable enzymes are variants or wild-types of the fungal serine proteases endogenous to Trichoderma reesei strain QM9414, Malbranchea cinnamomea strain ALK04122, Fusarium graminearum strain ALK01726, Fusarium equiseti strain CBS 119568 and Fusarium acuminatum strain CBS 124084. Examples of commercially available fungal serine proteases are Biotouch ROC and Biotouch Novia, both supplied by AB Enzymes, Darmstadt, Germany.

Amylase: Suitable amylases are alpha-amylases, including those of bacterial or fungal origin. Chemically or genetically modified mutants (variants) are included. A suitable alkaline alpha-amylase is derived from a strain of Bacillus, such as Bacillus licheniformis, Bacillus amyloliquefaciens, Bacillus stearothermophilus, Bacillus subtilis, or other Bacillus sp., such as Bacillus sp. NCIB 12289, NCIB 12512, NCIB 12513, sp 707, DSM 9375, DSM 12368, DSMZ no. 12649, KSM AP1378, KSM K36 or KSM K38. Suitable amylases include:

(a) alpha-amylase derived from Bacillus licheniformis (P06278, AMY_BACLI), and variants thereof, especially the variants with substitutions in one or more of the following positions: 15, 23, 105, 106, 124, 128, 133, 154, 156, 181, 188, 190, 197, 202, 208, 209, 243, 264, 304, 305, 391, 408, and 444.

(b) AA560 amylase (CBU30457, HD066534) and variants thereof, especially the variants with one or more substitutions in the following positions: 26, 30, 33, 82, 37, 106, 118, 128, 133, 149, 150, 160, 178, 182, 186, 193, 203, 214, 231, 256, 257, 258, 269, 270, 272, 283, 295, 296, 298, 299, 303, 304, 305, 311, 314, 315, 318, 319, 339, 345, 361, 378, 383, 419, 421, 437, 441, 444, 445, 446, 447, 450, 461, 471, 482, 484, optionally that also contain the deletions of D183* and G184*.

(c) variants exhibiting at least 90% identity with the wild-type enzyme from Bacillus SP722 (CBU30453, HD066526), especially variants with deletions in the 183 and 184 positions.

Suitable commercially available alpha-amylases are Duramyl®, Liquezyme® Termamyl®, Termamyl Ultra®, Natalase®, Supramyl®, Stainzyme®, Stainzyme Plus®, Fungamyl® and BAN® (Novozymes A/S), Bioamylase® and variants thereof (Biocon India Ltd.), Kemzym® AT 9000 (Biozym Ges. m.b.H, Austria), Rapidase®, Purastar®, Optisize HT Plus®, Enzysize®, Powerase® and Purastar Oxam®, Maxamyl® (Genencor International Inc.) and KAM® (KAO, Japan). Suitable amylases are Natalase®, Stainzyme® and Stainzyme Plus®.

Cellulase: The composition may comprise a cellulase. Suitable cellulases include those of bacterial or fungal origin. Chemically modified or protein engineered mutants are included. Suitable cellulases include cellulases from the genera Bacillus, Pseudomonas, Humicola, Fusarium, Thielavia, Acremonium, e.g., the fungal cellulases produced from Humicola insolens, Myceliophthora thermophila and Fusarium oxysporum.

Commercially available cellulases include Celluzyme®, and Carezyme® (Novozymes A/S), Clazinase®, and Puradax HA® (Genencor International Inc.), and KAC-500(B)® (Kao Corporation).

The cellulase can include microbial-derived endoglucanases exhibiting endo-beta-1,4-glucanase activity (E.C. 3.2.1.4), including a bacterial polypeptide endogenous to a member of the genus Bacillus sp. AA349 and mixtures thereof. Suitable endoglucanases are sold under the tradenames Celluclean® and Whitezyme® (Novozymes A/S, Bagsvaerd, Denmark).

The composition may comprise a cleaning cellulase belonging to Glycosyl Hydrolase family 45 having a molecular weight of from 17 kDa to 30 kDa, for example the endoglucanases sold under the tradename Biotouch® NCD, DCC and DCL (AB Enzymes, Darmstadt, Germany).

Suitable cellulases may also exhibit xyloglucanase activity, such as Whitezyme®.

Xyloglucanase: Suitable xyloglucanase enzymes may have enzymatic activity towards both xyloglucan and amorphous cellulose substrates. The enzyme may be a glycosyl hydrolase (GH) selected from GH families 5, 12, 44 or 74. The glycosyl hydrolase selected from GH family 44 is particularly suitable. Suitable glycosyl hydrolases from GH family 44 are the XYG1006 glycosyl hydrolase from Paenibacillus polyxyma (ATCC 832) and variants thereof.

Pectate lyase: Suitable pectate lyases are either wild-types or variants of Bacillus-derived pectate lyases (CAF05441, AAU25568) sold under the tradenames Pectawash®, Pectaway® and X-Pect® (from Novozymes A/S, Bagsvaerd, Denmark).

Mannanase: Suitable mannanases are sold under the tradenames Mannaway® (from Novozymes A/S, Bagsvaerd, Denmark), and Purabrite® (Genencor International Inc., Palo Alto, Calif.).

Bleaching enzyme: Suitable bleach enzymes include oxidoreductases, for example oxidases such as glucose, choline or carbohydrate oxidases, oxygenases, catalases, peroxidases, like halo-, chloro-, bromo-, lignin-, glucose- or manganese-peroxidases, dioxygenases or laccases (phenoloxidases, polyphenoloxidases). Suitable commercial products are sold under the Guardzyme® and Denilite® ranges from Novozymes. It may be advantageous for additional organic compounds, especially aromatic compounds, to be incorporated with the bleaching enzyme; these compounds interact with the bleaching enzyme to enhance the activity of the oxidoreductase (enhancer) or to facilitate the electron flow (mediator) between the oxidizing enzyme and the stain typically over strongly different redox potentials.

Other suitable bleaching enzymes include perhydrolases, which catalyse the formation of peracids from an ester substrate and peroxygen source. Suitable perhydrolases include variants of the Mycobacterium smegmatis perhydrolase, variants of so-called CE-7 perhydrolases, and variants of wild-type subtilisin Carlsberg possessing perhydrolase activity.

Identity. The relativity between two amino acid sequences is described by the parameter “identity”. For purposes of the present invention, the alignment of two amino acid sequences is determined by using the Needle program from the EMBOSS package (http://emboss.org) version 2.8.0. The Needle program implements the global alignment algorithm described in Needleman, S. B. and Wunsch, C. D. (1970) J. Mol. Biol. 48, 443-453. The substitution matrix used is BLOSUM62, gap opening penalty is 10, and gap extension penalty is 0.5.

Fabric-softener: Suitable fabric-softening agents include clay, silicone and/or quaternary ammonium compounds. Suitable clays include montmorillonite clay, hectorite clay and/or laponite clay. A suitable clay is montmorillonite clay. Suitable silicones include amino-silicones and/or polydimethylsiloxane (PDMS). A suitable fabric softener is a particle comprising clay and silicone, such as a particle comprising montmorillonite clay and PDMS.

Flocculant: Suitable flocculants include polyethylene oxide; for example having an average molecular weight of from 300,000 Da to 900,000 Da.

Suds suppressor: Suitable suds suppressors include silicone and/or fatty acid such as stearic acid.

Perfume: Suitable perfumes include perfume microcapsules, polymer assisted perfume delivery systems including Schiff base perfume/polymer complexes, starch-encapsulated perfume accords, perfume-loaded zeolites, blooming perfume accords, and any combination thereof. A suitable perfume microcapsule is melamine formaldehyde based, typically comprising perfume that is encapsulated by a shell comprising melamine formaldehyde. It may be highly suitable for such perfume microcapsules to comprise cationic and/or cationic precursor material in the shell, such as polyvinyl formamide (PVF) and/or cationically modified hydroxyethyl cellulose (catHEC).

Aesthetic: Suitable aesthetic particles include soap rings, lamellar aesthetic particles, geltin beads, carbonate and/or sulphate salt speckles, coloured clay particles, and any combination thereof.

### EXAMPLES

### Example 1

The improved cationic surfactant removal benefit of the method of the present invention was demonstrated in the following experiment.

A composition was prepared comprising alkyl ethoxylated sulphate anionic surfactant, a polydimethyl siloxane containing suds suppressor and sodium bicarbonate. This composition was labeled pre-treatment composition 1.

A second pre-treatment composition was prepared which was identical to pre-treatment composition 1, but which was also used in conjunction with a commercially available Lenor brand liquid softener, Pure Care Sensitive.

A third pre-treatment composition was prepared which was identical to pre-treatment composition 1, but which also comprised a variant having at least 90% sequence identity to wild-type lipase from Thermomyces lanuginosus and having sequence substitutions T231R and N233R.

A fourth pre-treatment composition was prepared which was identical to pre-treatment composition 3, but which was also used in conjunction with a commercially available Lenor brand liquid softener.

A fifth pre-treatment composition was prepared which was identical to pre-treatment composition 1, but which also comprised a variant corresponding to claim 5, part (u) of EP1290150B1.

A sixth pre-treatment composition was prepared which was identical to pre-treatment composition 5, but which was also used in conjunction with a commercially available Lenor brand liquid softener.

To summarise;
1. pre-treatment composition only
2. pre-treatment composition in conjunction with Lenor
3. pre-treatment composition comprising Lipex
4. pre-treatment composition comprising Lipex in conjunction with Lenor
5. pre-treatment composition comprising Humicola insolens cutinase
6. pre-treatment composition comprising Humicola insolens cutinase in conjunction with Lenor.

Standard fabric swatches TF7436-M polycotton (25×20 cm swatches) and Dacron 64 polyester (25×20 cm swatches) were obtained from Westlairds. Also obtained were standard Equest KC knitted cotton (25×20 cm) swatches. Two of each of these were added to a washing machine together with 455 g of cotton tea towels as ballast.

The swatches were then washed in the ‘short cotton cycle’ (40° C.) at 1600 rpm together with the relevant pre-treatment composition added to the drawer of the washing machine so that it would be added during the wash cycle and where applicable Lenor added to the drawer so that it would be added during the rinse cycle. The fabrics were then dried on a line. This was repeated so that all swatches had been washed four times together with the same pre-treatment composition and Lenor (where applicable), with drying between washes and a final tumble dry after the last wash. The pre-treatment compositions were prepared such that the 13 L wash liquor comprised 100 ppm linear alkylbenzene sulphonate anionic surfactant present in the wash liquor. Sodium bicarbonate was added to the wash liquor at a concentration of 400 ppm, and the suds suppressor (12.4% active) at a concentration of 46 ppm. The lipid esterase was added to the wash liquor at a concentration of 1 ppm (active enzyme protein). A volume of 70 ml of the standard Lenor liquid fabric softener was added to the drawer of the washing machine.

The lipid esterase concentration on polycotton and polyester fabrics for fabrics treated with pre-treatments 1-4 were tested using an enzyme linked immunosorbant assay (ELISA). A sample preparation buffer was first prepared by weighing 0.93 g Trizma base, 4.96 g sodium thiosulfate pentahydrate, 0.147 g calcium chloride and 29.22 g sodium chloride into a 1000 ml beaker. To this, 800 ml deionised water was added and stirred to dissolve the ingredients. To this, 1 g of bovine serum albumin (BSA) was added and the solution stirred. Hydrochloric acid was added to adjust the pH to 8 and then 0.1 g sodium azide was added. 1 ml of Tween 20 was then added. To this, the fabric swatch was added and agitated for 30 minutes. A volume of 25 ml of this was solution was then taken and added to a centrifuge tube and placed in sample rotator for at least 30 mins.

A volume of 100 μl of this was placed in the well of microtitre plate, covered and allowed to incubate for 90 mins. A volume of 10 μl of the appropriate detecting antibody (made using standard biochemical means) was added to 11 ml of blocking buffer (2 g of bovine serum albumin dissolved in 100 ml of wash buffer [wash buffer; 29.22 g sodium chloride, 1.86 g Trisma-base and 1 g bovine serum albumin, dissolved in desionised water, pH adjusted to 8, 0.5 ml Tween 20 added and the volume made up to 1000 ml]) and mixed gently to produce a detecting antibody solution. The microtitre plate was washed with wash buffer, and 100 μl of the detected antibody solution was added. To 11 ml of blocking buffer, 10 μl of a peroxide solution was added. The microtitre plate was washed with wash buffer and the peroxide in blocking buffer solution added. The plate was covered and allowed to stand for 60 mins at room temperature.

An OPD substrate solution was prepared by adding a 15 mg tablet of OPD (commercially available from Sigma) to 30 ml of a citrate/phosphate buffer (7.3 g of citric acid monohydrate and 23.87 g Na₂HPO₄.12H₂O dissolved in deionised water, pH adjusted to pH 5 and the volume made up to 1000 ml) in a centrifuge tube wrapped in foil. The tube was capped and mixed gently. To the tube, 10 μl of 30% hydrogen peroxide was added and the plate then washed with wash buffer. The plate was then washed with citrate/phosphate buffer and 100 μl of OPD substrate solution added to the well. Following this, 150 μl of 1M H₂SO₄ was added to the well to stop the reaction. The microtitre plate was read in a microtitre plate reader at 492 and 620 nm (dual wavelength mode). The 620 nm value was subtracted from the 492 nm value. The final values obtained were then compared to a calibration curve prepared earlier. Those skilled in the art would know how to prepare a standard calibration curve. From the calibration curve the amount of enzyme present on the fabric was calculated. Results can be seen in Table 1.

TABLE 1

| Pre- | | |
|---|---|---|
| treatment | Fabric | ng enzyme/g fabric |
| 1 | Polyester | 18400 |
| 2 | Polyester | 17900 |
| 3 | Polyester | 1000 |
| 4 | Polyester | 370 |
| 1 | Polycotton | 4700 |
| 2 | Polycotton | 28000 |
| 3 | Polycotton | 1030 |
| 4 | Polycotton | 2170 |

The test fabrics were then agitated in 0.01% aqueous solution of bromophenol blue a tergotometer. Bromophenol blue is a dye that complexes with cationic surfactants. The fabrics were contacted with the bromophenol blue for 5 minutes.

The fabrics were then rinsed in the tergotometer. The conditions were 200 rpm, for 5 minutes at 22° C. The rinse treatment solution also comprised 50 ppm linear alkylbenzene sulphonate anionic surfactant.

Fabrics were then Dried Overnight on Wire Racks.

Following drying, the fabrics were imaged using Colour-Eye imaging apparatus. The Colour-eye imaging apparatus measures the optical b value of the fabrics. A more negative b value indicates that cationic surfactant residues are present. The results can be seen in Tables 2 and 3 below.

TABLE 2
polycotton

| | | Standard |
|---|---|---|
| Treatment | b Value | Error |
| 1 | −9.19 | 0.49 |
| 2 | −17.05 | 0.38 |
| 3 | −7.94 | 0.14 |
| 4 | −7.82 | 0.19 |
| 5 | −8.83 | 0.38 |
| 6 | −9.00 | 0.74 |

(Standard error was calculated as SE=SD/√n where SD=standard deviation and n=number of external replicates)

As can be seen from Table 2, polycotton treated with treatment 1, i.e. no enzyme or fabric softener gave a b value of −9.19. Treatment 2, which also included fabric softener gave a b value of −17.05, indicating that there is more cationic residue present. However, treatments 3 to 6 all gave similar b values. This indicates that when the fabric was pre-treated with lipid esterase prior to addition of cationic fabric softener (treatments 4 and 6), the amount of cationic residue following washing was the same as when no cationic softener was added (treatments 3 and 5).

TABLE 3
Polyester and Cotton

| | |
|---|---|
| Polyester | Cotton |

| | | Standard | | Standard |
|---|---|---|---|---|
| Treatment | b Value | Error | b Value | Error |
| 1 | 2.61 | 0.07 | −14.91 | 0.17 |
| 2 | 0.57 | 1.12 | −29.57 | 0.65 |
| 3 | 3.02 | 0.08 | −14.66 | 0.17 |
| 4 | 2.70 | 0.42 | −13.92 | 0.63 |

As can be seen from Table 3, the same effect is seen again. Fabrics treated with treatment 2 show a much more negative b value on both polyester and cotton than fabrics treated with treatment 1. This indicates that fabrics treated with treatment 2 had residual cationic material remaining on them. However, fabrics treated with treatment 4 showed a b value that was similar to fabrics treated with treatment 3. Therefore, fabrics treated with treatment 4 had lower residual cationic material than fabrics treated with treatment 2.

### Examples 2-20

The following examples are of laundry detergent compositions suitable for use in step (iii);

### Examples 2-7

Granular laundry detergent compositions designed for hand washing or top-loading washing machines may be added to sufficient water to form a paste for direct contact with the surface to be treated, forming a concentrated cleaning composition.

| | 2 | 3 | 4 | 5 | 6 | 7 |
|---|---|---|---|---|---|---|
| | (wt %) | (wt %) | (wt %) | (wt %) | (wt %) | (wt %) |
| Linear alkylbenzenesulfonate | 20 | 22 | 20 | 15 | 20 | 20 |
| C₁₂₋₁₄ Dimethylhydroxyethyl | 0.7 | 0.2 | 1 | 0.6 | 0.0 | 0 |
| ammonium chloride | | | | | | |
| AE3S | 0.9 | 1 | 0.9 | 0.0 | 0.5 | 0.9 |
| AE7 | 0.0 | 0.0 | 0.0 | 1 | 0.0 | 3 |
| Sodium tripolyphosphate | 5 | 0.0 | 4 | 9 | 2 | 0.0 |
| Zeolite A | 0.0 | 1 | 0.0 | 1 | 4 | 1 |
| 1.6R Silicate (SiO₂:Na₂O at | 7 | 5 | 2 | 3 | 3 | 5 |
| ratio 1.6:1) | | | | | | |
| Sodium carbonate | 25 | 20 | 25 | 17 | 18 | 19 |
| Polyacrylate MW 4500 | 1 | 0.6 | 1 | 1 | 1.5 | 1 |
| Random graft copolymer¹ | 0.1 | 0.2 | 0.0 | 0.0 | 0.0 | 0.0 |
| Carboxymethyl cellulose | 1 | 0.3 | 1 | 1 | 1 | 1 |
| Stainzyme ® (20 mg active/g) | 0.1 | 0.2 | 0.1 | 0.2 | 0.1 | 0.1 |
| Bacterial protease (Savinase ®, | 0.1 | 0.1 | 0.1 | 0.1 | | 0.1 |
| 32.89 mg active/g) | | | | | | |
| Natalase ® (8.65 mg active/g) | 0.1 | 0.0 | 0.1 | 0.0 | 0.1 | 0.1 |
| Lipex ® (18 mg active/g) | 0.03 | 0.07 | 0.3 | 0.1 | 0.07 | 0.4 |
| Biotouch ® ROC (20 mg | 0.1 | 0.2 | 0.2 | 0.2 | 0.1 | 0.4 |
| active/g) | | | | | | |
| Fluorescent Brightener 1 | 0.06 | 0.0 | 0.06 | 0.18 | 0.06 | 0.06 |
| Fluorescent Brightener 2 | 0.1 | 0.06 | 0.1 | 0.0 | 0.1 | 0.1 |
| DTPA | 0.6 | 0.8 | 0.6 | 0.25 | 0.6 | 0.6 |
| MgSO₄ | 1 | 1 | 1 | 0.5 | 1 | 1 |
| Sodium Percarbonate | 0.0 | 5.2 | 0.1 | 0.0 | 0.0 | 0.0 |
| Sodium Perborate | 4.4 | 0.0 | 3.85 | 2.09 | 0.78 | 3.63 |
| Monohydrate | | | | | | |
| NOBS | 1.9 | 0.0 | 1.66 | 0.0 | 0.33 | 0.75 |
| TAED | 0.58 | 1.2 | 0.51 | 0.0 | 0.015 | 0.28 |
| Sulphonated zinc | 0.0030 | 0.0 | 0.0012 | 0.0030 | 0.0021 | 0.0 |
| phthalocyanine | | | | | | |
| S-ACMC | 0.1 | 0.0 | 0.0 | 0.0 | 0.06 | 0.0 |
| Direct Violet 9 | 0.0 | 0.0 | 0.0003 | 0.0005 | 0.0003 | 0.0 |
| Acid Blue 29 | 0.0 | 0.0 | 0.0 | 0.0 | 0.0 | 0.0003 |

| | |
|---|---|
| Sulfate/Moisture | Balance |

### Examples 8-13

Granular laundry detergent compositions designed for front-loading automatic washing machines may be added to sufficient water to form a paste for direct contact with the surface to be treated, forming a concentrated cleaning compostion.

| | 8 | 9 | 10 | 11 | 12 | 13 |
|---|---|---|---|---|---|---|
| | (wt %) | (wt %) | (wt %) | (wt %) | (wt %) | (wt %) |
| Linear alkylbenzenesulfonate | 8 | 7.1 | 7 | 6.5 | 7.5 | 7.5 |
| AE3S | 0 | 4.8 | 0 | 5.2 | 4 | 4 |
| C12-14 Alkylsulfate | 1 | 0 | 1 | 0 | 0 | 0 |
| AE7 | 2.2 | 0 | 3.2 | 0 | 0 | 0 |
| C₁₀₋₁₂ Dimethyl | 0.75 | 0.94 | 0.98 | 0.98 | 0 | 0 |
| hydroxyethylammonium chloride | | | | | | |
| Crystalline layered silicate (δ- | 4.1 | 0 | 4.8 | 0 | 0 | 0 |
| Na₂Si₂O₅) | | | | | | |
| Zeolite A | 5 | 0 | 5 | 0 | 2 | 2 |
| Citric Acid | 3 | 5 | 3 | 4 | 2.5 | 3 |
| Sodium Carbonate | 15 | 20 | 14 | 20 | 23 | 23 |
| Silicate 2R (SiO₂:Na₂O at ratio | 0.08 | 0 | 0.11 | 0 | 0 | 0 |
| 2:1) | | | | | | |
| Soil release agent | 0.75 | 0.72 | 0.71 | 0.72 | 0 | 0 |
| Acrylic Acid/Maleic Acid | 1.1 | 3.7 | 1.0 | 3.7 | 2.6 | 3.8 |
| Copolymer | | | | | | |
| Carboxymethylcellulose | 0.15 | 1.4 | 0.2 | 1.4 | 1 | 0.5 |
| Bacterial protease (84 mg | 0.2 | 0.2 | 0.3 | 0.15 | 0.12 | 0.13 |
| active/g) | | | | | | |
| Stainzyme ® (20 mg active/g) | 0.2 | 0.15 | 0.2 | 0.3 | 0.15 | 0.15 |
| Lipex ® (18.00 mg active/g) | 0.05 | 0.15 | 0.1 | 0 | 0 | 0 |
| Natalase ® (8.65 mg active/g) | 0.1 | 0.2 | 0 | 0 | 0.15 | 0.15 |
| Celluclean ™ (15.6 mg active/g) | 0 | 0 | 0 | 0 | 0.1 | 0.1 |
| Biotouch ® ROC (20 mg active/g) | 0.2 | 0.1 | 0.2 | 0.2 | 0.2 | 0.2 |
| TAED | 3.6 | 4.0 | 3.6 | 4.0 | 2.2 | 1.4 |
| Percarbonate | 13 | 13.2 | 13 | 13.2 | 16 | 14 |
| Na salt of Ethylenediamine-N,N′- | 0.2 | 0.2 | 0.2 | 0.2 | 0.2 | 0.2 |
| disuccinic acid, (S,S) isomer | | | | | | |
| (EDDS) | | | | | | |
| Hydroxyethane di phosphonate | 0.2 | 0.2 | 0.2 | 0.2 | 0.2 | 0.2 |
| (HEDP) | | | | | | |
| MgSO₄ | 0.42 | 0.42 | 0.42 | 0.42 | 0.4 | 0.4 |
| Perfume | 0.5 | 0.6 | 0.5 | 0.6 | 0.6 | 0.6 |
| Suds suppressor agglomerate | 0.05 | 0.1 | 0.05 | 0.1 | 0.06 | 0.05 |
| Soap | 0.45 | 0.45 | 0.45 | 0.45 | 0 | 0 |
| Sulphonated zinc phthalocyanine | 0.0007 | 0.0012 | 0.0007 | 0 | 0 | 0 |
| (active) | | | | | | |
| S-ACMC | 0.01 | 0.01 | 0 | 0.01 | 0 | 0 |
| Direct Violet 9 (active) | 0 | 0 | 0.0001 | 0.0001 | 0 | 0 |

| | |
|---|---|
| Sulfate/Water & Miscellaneous | Balance |

Any of the above compositions is used to launder fabrics in the second step at a concentration of 7000 to 10000 ppm in water, 20-90° C., and a 5:1 water:cloth ratio. The typical pH is about 10. The fabrics are then dried. In one aspect, the fabrics are actively dried using a dryer. In one aspect, the fabrics are actively dried using an iron. In another aspect, the fabrics are merely allowed to dry on a line wherein they are exposed to air and optionally sunlight.

### Examples 14-19

### Heavy Duty Liquid Laundry Detergent Compositions

| | 14 | 15 | 16 | 17 | 18 | 19 |
|---|---|---|---|---|---|---|
| | (wt %) | (wt %) | (wt %) | (wt %) | (wt %) | (wt %) |
| AES C₁₂₋₁₅ alkyl | 11 | 10 | 4 | 6.32 | 0 | 0 |
| ethoxy (1.8) | | | | | | |
| sulfate | | | | | | |
| AE3S | 0 | 0 | 0 | 0 | 2.4 | 0 |
| Linear alkyl | 1.4 | 4 | 8 | 3.3 | 5 | 8 |
| benzene sulfonate | | | | | | |
| HSAS | 3 | 5.1 | 3 | 0 | 0 | 0 |
| Sodium formate | 1.6 | 0.09 | 1.2 | 0.04 | 1.6 | 1.2 |
| Sodium hydroxide | 2.3 | 3.8 | 1.7 | 1.9 | 1.7 | 2.5 |
| Monoethanolamine | 1.4 | 1.49 | 1.0 | 0.7 | 0 | 0 |
| Diethylene glycol | 5.5 | 0.0 | 4.1 | 0.0 | 0 | 0 |
| AE9 | 0.4 | 0.6 | 0.3 | 0.3 | 0 | 0 |
| AE7 | 0 | 0 | 0 | 0 | 2.4 | 6 |
| Chelant | 0.15 | 0.15 | 0.11 | 0.07 | 0.5 | 0.11 |
| Citric Acid | 2.5 | 3.96 | 1.88 | 1.98 | 0.9 | 2.5 |
| C₁₂₋₁₄ dimethyl | 0.3 | 0.73 | 0.23 | 0.37 | 0 | 0 |
| Amine Oxide | | | | | | |
| C₁₂₋₁₈ Fatty Acid | 0.8 | 1.9 | 0.6 | 0.99 | 1.2 | 0 |
| 4-formyl- | 0 | 0 | 0 | 0 | 0.05 | 0.02 |
| phenylboronic acid | | | | | | |
| Borax | 1.43 | 1.5 | 1.1 | 0.75 | 0 | 1.07 |
| Ethanol | 1.54 | 1.77 | 1.15 | 0.89 | 0 | 3 |
| Ethoxylated (EO₁₅) | 0.3 | 0.33 | 0.23 | 0.17 | 0.0 | 0.0 |
| tetraethylene | | | | | | |
| pentamine | | | | | | |
| Ethoxylated | 0.8 | 0.81 | 0.6 | 0.4 | 1 | 1 |
| hexamethylene | | | | | | |
| diamine | | | | | | |
| 1,2-Propanediol | 0.0 | 6.6 | 0.0 | 3.3 | 0.5 | 2 |
| Bacterial protease | 0.8 | 0.6 | 0.7 | 0.9 | 0.7 | 0.6 |
| (40.6 mg active/g) | | | | | | |
| Mannaway ® (25 | 0.07 | 0.05 | 0.045 | 0.06 | 0.04 | 0.045 |
| mg active/g) | | | | | | |
| Stainzyme ® (15 | 0.3 | 0.2 | 0.3 | 0.1 | 0.2 | 0.4 |
| mg active/g) | | | | | | |
| Natalase ® (29 mg | 0 | 0.2 | 0.1 | 0.15 | 0.07 | 0 |
| active/g) | | | | | | |
| Lipex ® (18 mg | 0.4 | 0.2 | 0.3 | 0.1 | 0.2 | 0 |
| active/g) | | | | | | |
| Biotouch ® ROC | 0.2 | 0.1 | 0.2 | 0.2 | 0.1 | 0.1 |
| (20 mg active/g) | | | | | | |
| Liquitint ® Violet | 0.006 | 0.002 | 0 | 0 | 0 | 0.002 |
| CT (active) | | | | | | |
| S-ACMC | — | — | 0.01 | 0.05 | 0.01 | 0.02 |
| Water, perfume, | Balance | | | | | |
| dyes & other | | | | | | |
| components | | | | | | |

### Example 20

This composition may be enclosed in a polyvinyl alcohol pouch.

| | 19 |
|---|---|
| | (wt %) |
| Alkylbenzene sulfonic acid | 21.0 |
| C₁₄₋₁₅ alkyl 8-ethoxylate | 18.0 |
| C₁₂₋₁₈ Fatty acid | 15.0 |
| Bacterial protease (40.6 mg active/g) | 1.5 |
| Natalase ® (29 mg active/g) | 0.2 |
| Mannanase (Mannaway ®, 11 mg active/g) | 0.1 |
| Xyloglucanase (Whitezyme ®, 20 mg active/g) | 0.2 |
| Biotouch ® ROC (20 mg active/g) | 0.2 |
| A compound having the following general | 2.0 |
| structure: bis((C₂H₅O)(C₂H₄O)n)(CH₃)—N⁺— | |
| CₓH₂ₓ—N⁺—(CH₃)-bis((C₂H₅O)(C₂H₄O)n), | |
| wherein n = from 20 to 30, and x = from 3 to 8, | |
| or sulphated or sulphonated variants thereof | |
| Ethoxylated Polyethylenimine ² | 0.8 |
| Hydroxyethane diphosphonate (HEDP) | 0.8 |
| Fluorescent Brightener 1 | 0.2 |
| Solvents (1,2 propanediol, ethanol), stabilizers | 15.0 |
| Hydrogenated castor oil derivative structurant | 0.1 |
| Perfume | 1.6 |
| Core Shell Melamine-formaldehyde | 0.10 |
| encapsulate of perfume | |
| Ethoxylated thiophene Hueing Dye | 0.004 |
| Buffers (sodium hydroxide, | To pH 8.2 |
| Monoethanolamine) | |
| Water* and minors (antifoam, aesthetics) | To 100% |

*Based on total cleaning and/or treatment composition weight, a total of no more than 7% water
¹ Random graft copolymer is a polyvinyl acetate grafted polyethylene oxide copolymer having a polyethylene oxide backbone and multiple polyvinyl acetate side chains. The molecular weight of the polyethylene oxide backbone is about 6000 and the weight ratio of the polyethylene oxide to polyvinyl acetate is about 40 to 60 and no more than 1 grafting point per 50 ethylene oxide units.
² Polyethyleneimine (MW = 600) with 20 ethoxylate groups per —NH.
*Remark: all enzyme levels expressed as % enzyme raw material

### Raw Materials and Notes For Composition Examples 2-20

Linear alkylbenzenesulfonate having an average aliphatic carbon chain length C₁₁-C₁₂ supplied by Stepan, Northfield, Ill., USA
C₁₂₋₁₄ Dimethylhydroxyethyl ammonium chloride, supplied by Clariant GmbH, Sulzbach, Germany
AE3S is C₁₂₋₁₅ alkyl ethoxy (3) sulfate supplied by Stepan, Northfield, Ill., USA
AE7 is C₁₂₋₁₅ alcohol ethoxylate, with an average degree of ethoxylation of 7, supplied by Huntsman, Salt Lake City, Utah, USA
AE9 is C₁₂₋₁₃ alcohol ethoxylate, with an average degree of ethoxylation of 9, supplied by Huntsman, Salt Lake City, Utah, USA
HSAS is a mid-branched primary alkyl sulfate with carbon chain length of about 16-17 Sodium tripolyphosphate is supplied by Rhodia, Paris, France
Zeolite A is supplied by Industrial Zeolite (UK) Ltd, Grays, Essex, UK
1.6R Silicate is supplied by Koma, Nestemica, Czech Republic
Sodium Carbonate is supplied by Solvay, Houston, Tex., USA
Polyacrylate MW 4500 is supplied by BASF, Ludwigshafen, Germany
Carboxymethyl cellulose is Finnfix® V supplied by CP Kelco, Arnhem, Netherlands
Suitable chelants are, for example, diethylenetetraamine pentaacetic acid (DTPA) supplied by Dow Chemical, Midland, Mich., USA or Hydroxyethane di phosphonate (HEDP) supplied by Solutia, St Louis, Mo., USA Bagsvaerd, Denmark
Savinase®, Natalase®, Stainzyme®, Lipex®, Celluclean™, Mannaway® and Whitezyme® are all products of Novozymes, Bagsvaerd, Denmark.
Biotouch® ROC is a product of AB Enzymes, Darmstadt, Germany.
Bacterial protease (examples 8-13) described in U.S. Pat. No. 6,312,936 B1 supplied by Genencor International, Palo Alto, Calif., USA
Bacterial protease (examples 14-20) described in U.S. Pat. No. 4,760,025 is supplied by Genencor International, Palo Alto, Calif., USA
Fluorescent Brightener 1 is Tinopal® AMS, Fluorescent Brightener 2 is Tinopal® CBS-X, Sulphonated zinc phthalocyanine and Direct Violet 9 is Pergasol® Violet BN-Z all supplied by Ciba Specialty Chemicals, Basel, Switzerland
Sodium percarbonate supplied by Solvay, Houston, Tex., USA
Sodium perborate is supplied by Degussa, Hanau, Germany
NOBS is sodium nonanoyloxybenzenesulfonate, supplied by Future Fuels, Batesville, Ark., USA
TAED is tetraacetylethylenediamine, supplied under the Peractive® brand name by Clariant GmbH, Sulzbach, Germany
S-ACMC is carboxymethylcellulose conjugated with C.I. Reactive Blue 19, sold by Megazyme, Wicklow, Ireland under the product name AZO-CM-CELLULOSE, product code S-ACMC.
Soil release agent is Repel-o-tex® PF, supplied by Rhodia, Paris, France
Acrylic Acid/Maleic Acid Copolymer is molecular weight 70,000 and acrylate:maleate ratio 70:30, supplied by BASF, Ludwigshafen, Germany
Na salt of Ethylenediamine-N,N′-disuccinic acid, (S,S) isomer (EDDS) is supplied by Octel, Ellesmere Port, UK
Hydroxyethane di phosphonate (HEDP) is supplied by Dow Chemical, Midland, Mich., USA
Suds suppressor agglomerate is supplied by Dow Corning, Midland, Mich., USA HSAS is mid-branched alkyl sulfate as disclosed in U.S. Pat. No. 6,020,303 and U.S. Pat. No. 6,060,443 C₁₂₋₁₄ dimethyl Amine Oxide is supplied by Procter & Gamble Chemicals, Cincinnati, Ohio, USA
Liquitint® Violet CT is supplied by Milliken, Spartanburg, S.C., USA.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A method of laundering a fabric, comprising the steps of;
i) contacting a fabric with a lipid esterase;
ii) contacting the fabric from step (i) with a cationically charged fabric softening active, wherein the cationically charged fabric softening active is a substrate for the lipid esterase;
iii) contacting the fabric from step (ii) with a laundry detergent composition, wherein the laundry detergent composition comprises an anionic detersive surfactant, wherein the anionic detersive surfactant is present at the ratio of anionic surfactant to fabric on a weight to weight basis of from about 1:150 to about 1:500.

2. A method according to claim 1, wherein the lipid esterase comprises at least a first and a second lipid esterase.

3. A method according to claim 1, wherein the fabric in step (iii) is contacted with a laundry detergent composition in a wash cycle of an automatic washing machine and wherein the length of the wash cycle is at least about 30 seconds, but no more than about 1 hour.

4. A method according to claim 3, wherein the length of the wash cycle is at least about 3 mins, but no more than about 45 mins.

5. A method according to claim 4, wherein the length of the wash cycle is at least about 6 mins, but no more than about 30 mins.

6. A method according to claim 1, wherein the fabric in step (iii) is contacted with a laundry detergent composition in a wash cycle of an automatic washing machine and wherein the wash cycle is run at a temperature of between about 5° C. and about 50° C.

7. A method according to claim 6, wherein the temperature is between about 10° C. and about 30° C.

8. A method according to claim 1, wherein the lipid esterase is selected from E.C. class 3.1.

9. A method according to claim 8, wherein the lipid esterase is selected from E.C. class 3.1.1.1, E.C. class 3.1.1.3, E.C. class 3.1.1.74 or a combination thereof.

10. A method according to claim 9, wherein the lipid esterase is selected from class E.C. 3.1.1.3.

11. A method according to claim 1 wherein the lipid esterase comprises a variant having at least about 90% sequence identity to wild-type lipase from Thermomyces lanuginosus and having sequence substitutions T231R and N233R, or a variant corresponding to claim 5, part (u) of EP1290150B1, or a combination thereof.

12. A method according to claim 1, wherein in step (i) the fabric is contacted with a lipid esterase the lipid esterase being present at a concentration of between about 30 and about 55,000 ng enzyme/g fabric.

13. A method according to claim 1, wherein the cationic charged fabric softening active comprises a cationic surfactant.

14. A method according to claim 13, wherein the cationic surfactant comprises a quaternary ammonium compound.

15. A method according to any preceding claims, wherein the detersive surfactant comprises an anionic surfactant,

16. A method according to claim 15, wherein the anionic surfactant is selected from linear alkyl benzene sulfonate, alkoxylated anionic surfactant, or a combination thereof.

17. A method according to claim 1, wherein the laundry detergent composition of step (iii) comprises a hueing agent, a polymer or a combination thereof.

18. A method according to claim 1, wherein the laundry detergent composition of step (iii) comprises from about 0 wt % to about 10 wt % zeolite builder on an anhydrous basis, from about 0 wt % to about 10 wt % phosphate builder, or a combination thereof.

19. A method according to claim 1, wherein the fabric in step (iii) is pre-treated with the laundry detergent composition prior to being subjected to the wash cycle of an automatic washing machine.

20. The use of a lipid esterase according to claim 1 deposited on a fabric to improve the removal of a fabric softening active from the fabric in a subsequent wash.
